(19) United States
(12) Patent Application Publication
(10) Pub. No.: US 2025/0336225 A1
(43) Pub. Date: Oct. 30, 2025

(54) SYSTEMS AND METHODS FOR AUTOMATED TEXT GENERATION USING NEURAL NETWORKS

(71) Applicant: Samsung Electronics Co., Ltd., Suwon-si (KR)

(72) Inventors: Manali SHARMA, San Jose, CA (US); Juanyan WANG, San Diego, CA (US); Sai Krishna Reddy MUDHIGANTI, San Jose, CA (US)

(21) Appl. No.: 19/186,502

(22) Filed: Apr. 22, 2025

Related U.S. Application Data
(60) Provisional application No. 63/639,549, filed on Apr. 26, 2024.
(60) Provisional application No. 63/672,666, filed on Jul. 17, 2024.

(51) Int. Cl. G06V 30/19; G06N 3/0455; G06N 3/08

(52) U.S. Cl. CPC G06V 30/19133; G06N 3/0455; G06N 3/08; G06V 30/19093; G06V 30/19127

(57) ABSTRACT

A method is disclosed for using an artificial neural network (ANN) for automated text generation, the method includes, a) receiving, through an interface of a computing device, one or more inputs, b) extracting data from the one or more inputs, resulting in extracted data, c) performing a mapping mechanism based on the extracted data, the mapping mechanism resulting in mapped data instances, d) training a first ANN based on at least a first set of mapped data instances, wherein the first set of mapped data instances require a similarity measurement, e) determining a weight for at least one encoder and at least one decoder, based on the training of the first ANN, f) providing, at the encoder, a sequence of mapped data instances, g) generating, at the decoder, based on at least a first set of the sequence of mapped data instances, a first processed text section, S, that corresponds to the first set of mapped data instances, h) determining if the first processed text section accurately corresponds to the first set of mapped data instances and i) generating, at the decoder, a revised processed text section rS, if the first processed text section in (g) does not accurately correspond to the mapped data instances.

### CROSS-REFERENCE TO RELATED APPLICATION

This application claims the priority benefit under 35 U.S.C. § 119(e) to U.S. Provisional Application No. 63/639,549 filed on Apr. 26, 2024 and U.S. Provisional Application No. 63/672,666 filed on Jul. 17, 2024, the disclosures of which are incorporated by reference in their entirety as if fully set forth herein.

### TECHNICAL FIELD

The disclosure generally relates to automated writing. More particularly, the subject matter disclosed herein relates to improvements to systems and methods for automated text generation for a specific task.

### SUMMARY

In recent years, Large Language Models (LLMs) have demonstrated impressive performances across various NLP tasks. However, their potential for automating the task of writing specific documents (e.g., patent documents) remains relatively unexplored. Disclosed herein are systems and methods intended to address the shortcomings in the art and may provide additional or alternative advantages as well.

(A1) A method of using an artificial neural network (ANN) for automated document generation, the method including a) receiving, through an interface of a computing device, one or more inputs, b) extracting data from the one or more inputs, resulting in extracted data, c) performing a mapping mechanism based on the extracted data, the mapping mechanism resulting in mapped data instances, d) training a first ANN based on at least a first set of mapped data instances, wherein the first set of mapped data instances require a similarity measurement, e) determining a weight for at least one encoder and at least one decoder, based on the training of the first ANN, f) providing, at the encoder, a sequence of mapped data instances, g) generating, at the decoder, based on at least a first set of the sequence of mapped data instances, a first processed text section, S, that corresponds to the first set of mapped data instances, h) determining if the first processed text section accurately corresponds to the first set of mapped data instances and i) regenerating, at the decoder, a revised processed text section rS, if the first processed text section in (g) does not accurately correspond to the mapped data instances.

(A2) The method of (A1), wherein extracting data includes: a) extracting text, C, from the one or more inputs, b) generating text features, C′ for each of an extracted text C, c) extracting images, I, from the one or more inputs, d) extracting description of images, B, from the one or more inputs and e) extracting component names, Z, and component numbers, num, for each of the images, i_{z}^{num}, in I.

(A3) The method of (A2), wherein extracting text, C, from the one or more inputs includes extracting a sequence of patent claims for a first patent document.

(A4) The method of (A2), wherein the mapping mechanism includes: mapping each of the text features, C′, with at least one of the images, I and mapping each of the component names, Z, and component numbers, num, for each of the images, i_{z}^{num}, with at least one of the text features, C.

(A5) The method of (A4) wherein the mapping mechanism further includes, mapping at least a first image description, B′, to an extracted text feature, C′.

(A6) The method of (A4), wherein the mapping mechanism defines a relationship between each of the extracted data.

(A7) The method of (A4), wherein the mapping mechanism is manually user defined.

(A8) The method of (A1), further including validating the mapping of each of the text features, C′, with each of the images, I, using an element validation module.

(A9) The method of (A1), further including, training a second artificial neural network configured to receive one or more outputs of the first artificial neural network and generate a specific text output.

(A10) The method of (A1), wherein a weight of each encoder and a weigh of each decoder of the first ANN is derived from the training of the first ANN, based on at least the first set of mapped data instances.

(A11) The method of (A1), wherein the first processed text section can be any text document including a patent document.

(A12) The method of (A11), wherein the processed text section is one or more portions of the patent document.

(A13) The method of (A1), wherein the similarity measurement is a threshold between 0.1-0.3.

(A14) The method of (A1), wherein the similarity measurement depends on cosine similarity and BLEU-1 and BLEU-2 scores.

(A15) The method of (A1), wherein accurately corresponding to the first set of mapped data instances requires that the first processed text section accurately describes the first set of mapped data instances.

(B1) A method of using an artificial neural network (ANN) for automated document generation, the method using a transformer, a set of multiple encoders and multiple decoders, the method including obtaining training data by using at least one text input according to a text source category and using a corresponding output text (separated by a target category), generating output vectors representing a probabilistic distribution over various elements of a text descriptive library from the decoder, c) determining an error measure between the outputted probabilistic distributions and a ground truth text from the training data and d) modifying at least one parameter of a sequence-sequence multiple encoders-multiple decoders model based on the error measure.

(C1) A computer-implemented method of generating output data, the method being performed by at least one processor and including: a) receiving, through an interface of a computing device, one or more inputs, b) extracting data from the one or more inputs, resulting in extracted data, c) performing a mapping mechanism based on the extracted data, the mapping mechanism resulting in mapped data instances, d) training a first artificial neural network based on at least a first set of mapped data instances, wherein the first set of mapped data instances require a similarity measurement, e) determining a weight for at least one encoder and at least one decoder, based on the training of the artificial neural network, f) providing, at the encoder, a sequence of mapped data instances, g) generating, at the decoder, based on at least a first set of the sequence of mapped data instances, a first processed text section, S, h) determining if the first processed text section accurately corresponds to the mapped data instances and i) generating, at the decoder, a revised processed text section rS, if the first processed text section in (h) does not accurately correspond to the mapped data instances.

(D1) A method for encoding data for transmission from a source to a destination over a communication channel, the method being performed by at least one processor and including: a) obtaining a data stream comprising a plurality of inputs, b) extracting data from the one or more inputs, resulting in a plurality of extracted data, c) determining a matching of each extracted data of the plurality of extracted data from a first encoder table, resulting in a plurality of matched data instances, d) encoding, at an encoder, a similarity measurement of a first set of mapped data instances of a plurality of mapped data instances, e) training a first neural network based on at least a first set of mapped data instances, f) generating a weight for the encoder based on the training of the first neural network, g) providing at the encoder a first sequence of mapped of data instances, h) applying an encoding function to each mapped data instance of the first sequence of mapped of data instances, i) generating, at a decoder, based on at least a first set of the first sequence of mapped data instances, a first processed text section, S, j) determining if the first processed text section accurately describes the mapped data instances and k) regenerating, at the decoder, a revised processed text section rS, if the first processed text section in (i) does not accurately describe the mapped data instances.

(E1) A method of decoding a sequence of mapped data instances, the method including:
a) obtaining a first sequence of mapped data instances, b) decoding a first mapped data instance from the first sequence of mapped data instances, c) mapping an output S′ for the first mapped data instance based on a training of a first neural network using probabilistic distributions of each decoder to generate a next more probable word, d) determining, based on the mapping of output S′ for the first mapped data instance, whether a constraint violation is met, e) re-mapping an output S′ for the first mapped data instance if the constraint violation is not met and f) generating an output stream by iteratively applying a decoding function to each mapped data instance of the first sequence of mapped data instances.

### BRIEF DESCRIPTION OF THE DRAWING

In the following section, the aspects of the subject matter disclosed herein will be described with reference to exemplary embodiments illustrated in the figures.

FIG. 1A is a block diagram of an automated draft generation system, according to one or more embodiments of the present disclosure.

FIG. 1B is a block diagram of a suitable computing environment for the automated draft generation system, in which described embodiments may be implemented, according to one or more embodiments of the present disclosure.

FIG. 2A is a block diagram depicting input sources and output examples for the automated draft generation system, according to some embodiments of the present disclosure.

FIG. 2B is a block diagram depicting input and output for an automated draft generation system, according to some embodiments of the present disclosure.

FIG. 3 is a block diagram depicting various input types for the encoder and various output types for the decoder for the automated draft generation system, according to some embodiments of the present disclosure.

FIG. 4 is a diagram depicting multiple encoder, single decoder for the automated draft generation system shown in FIGS. 2A-2B, according to some embodiments of the present disclosure.

FIG. 5 is a diagram depicting single encoder, multiple decoder for the automated draft generation system shown in FIGS. 2A-2B, according to some embodiments of the present disclosure.

FIG. 6 is a diagram depicting a multiple encoder, multiple decoder for the draft generation system shown in FIGS. 2A-2B, according to some embodiments of the present disclosure.

FIG. 7 depicts an exemplary home page GUI for the draft generation system, according to some embodiments of the present disclosure.

FIG. 8 depicts a drafts page GUI depicting various drafts created by a user for the draft generation system, according to some embodiments of the present disclosure.

FIG. 9 depicts an input page GUI, where input documents are uploaded for the draft generation system, according to some embodiments of the present disclosure.

FIG. 10A depicts an input claims page GUI for the draft generation system, according to some embodiments of the present disclosure.

FIG. 10B depicts input figures page GUI for the draft generation system, according to some embodiments of the present disclosure.

FIG. 11A-11B depicts a claim feature mapping tool GUI, according to some embodiments of the present disclosure.

FIG. 12 depicts mapping component names and numberings to claim features GUI for the draft generation system, according to some embodiments of the present disclosure.

FIG. 13 depicts a draft output page GUI for the draft generation system, according to some embodiments of the present disclosure.

FIG. 14 depicts a draft editing page GUI for the draft generation system, according to some embodiments of the present disclosure.

FIG. 15A-15C is a flowchart depicting example operations of a method depicted in at least FIGS. 2A-14, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Automating the generation of human-quality documents, for example, patents, remains challenging for large language models (LLMs). With regards to patents, there are certain requirements that need to be met. For example, each patent claim may need to be adequately supported in the specification and the specification may need to describe the invention in sufficient details using the associated drawings. This is just one of many technical and legal requirements that a patent needs to meet. Patents contain specific and nuanced technical information compared to other text documents (e.g. general web text), making it difficult for the LLMs to capture all the relevant pieces of information pertaining to an invention to generate a coherent specification. Further, a patent specification usually spans several pages, thus presenting another challenge for most of the LLMs which are limited by their token lengths, e.g., 512, 1024, 2048, or 8192 tokens. Moreover, most pretrained LLMs are not trained on patent data, and thus cannot generate text in legal writing style.

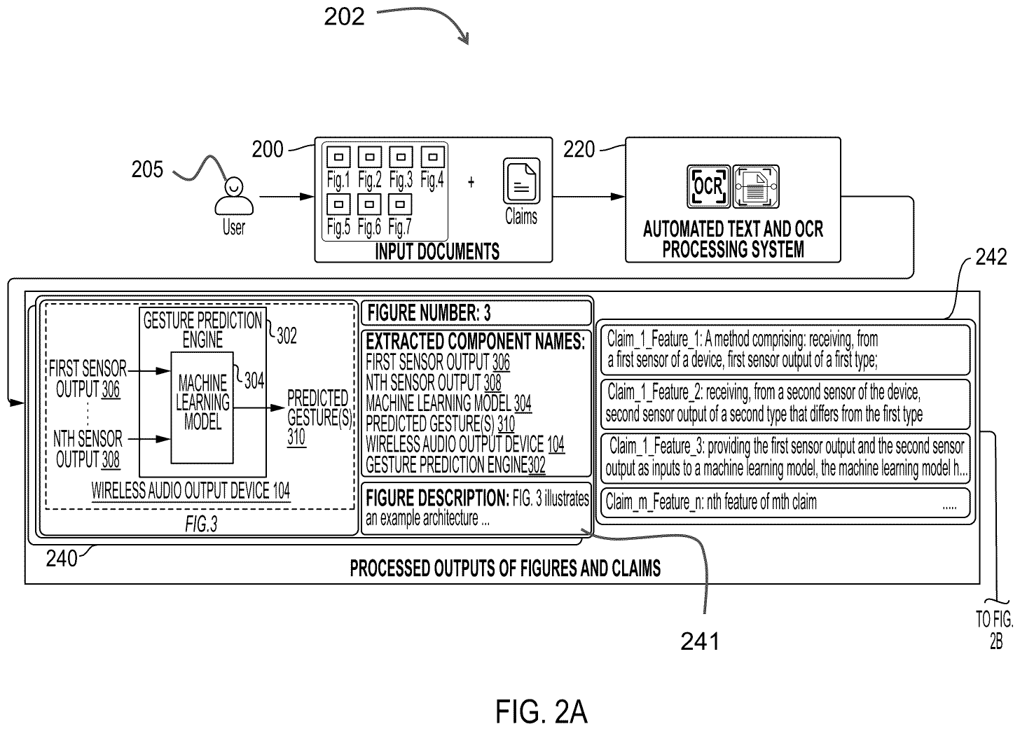

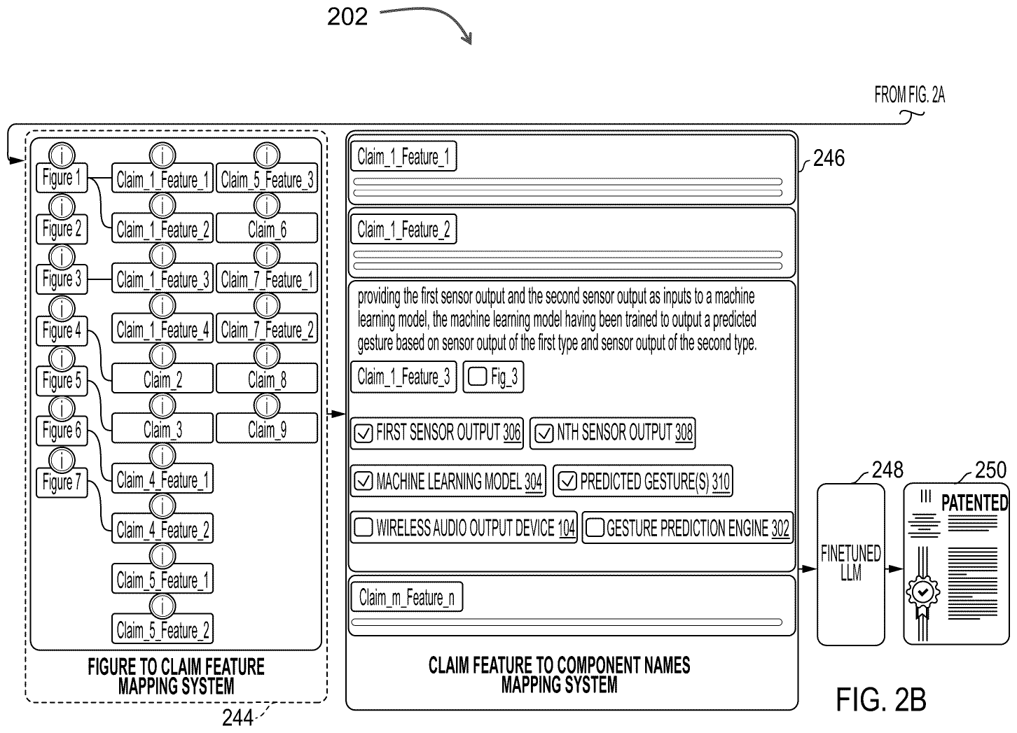

In one embodiment, the solution presented for the addressed issues above, is an automated patent generation system. In one embodiment, the system obtains a set of patent claims and any associated drawing text as input (e.g., this is depicted in at least FIGS. 2A-2B). The system may first preprocesses and enhances the input sources (e.g., claims) to improve its readability and structure, facilitating a better comprehension by the LLMs. The enhanced text is then passed to a fine-tuned LLM, which may be specifically trained on publicly available patent data to learn the stylistic and structural conventions of patent writing. This training may be done over thousands of available patent documents. This may enable the model to generate high-quality patent specifications that align with legal and technical standards. As such, the system may act as an interactive patent drafting assistant, providing the users with an intuitive and real-time interface to streamline the arduous patent writing process.

To enhance the generative models' comprehension of the complex task of writing a patent specification, a model-agnostic method for training generative LLMs with enriched training datasets may be presented herein. The disclosed method may be trained on thousands of patents from the USPTO using automatic evaluation metrics for natural language generation.

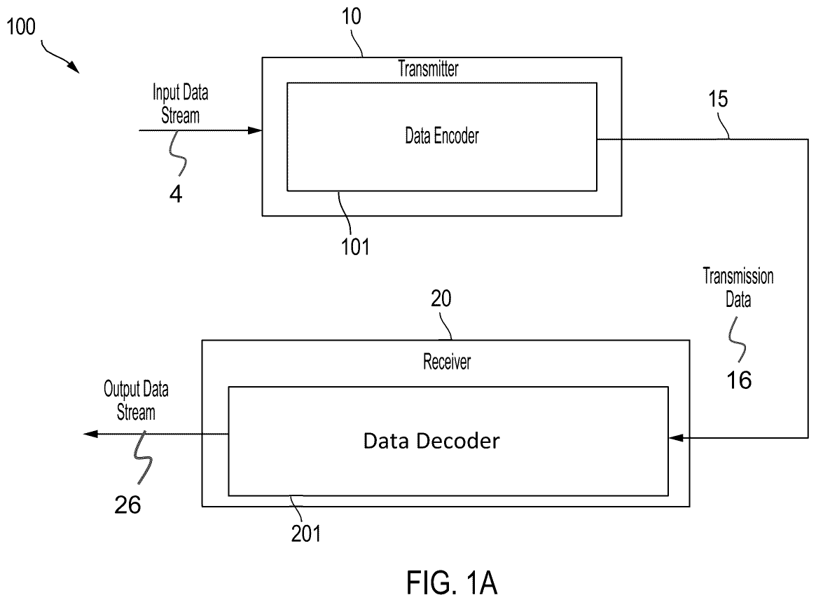

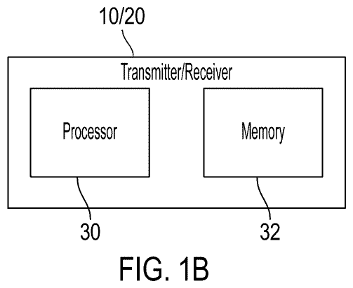

Referring to FIG. 1A, in some embodiments, the data communication system 100 may include input data stream 4, a transmitter 10, a communication channel (e.g., serial communication channel) 15, transmission data 16, receiver 20 and output data stream 26. The transmitter 10 may include, at least, a data compressor (not shown) for performing compression on the input data stream 4 and for encoding the input data stream 4 to generate transmission data stream 16 for transmission through the communication channel 15 to the receiver 20. The receiver 20 may include, at least, a data decompressor (not shown) performing decompression on the data stream received by the receiver 20 and a decoder 201 for decoding the data stream to generate the output data stream 26.

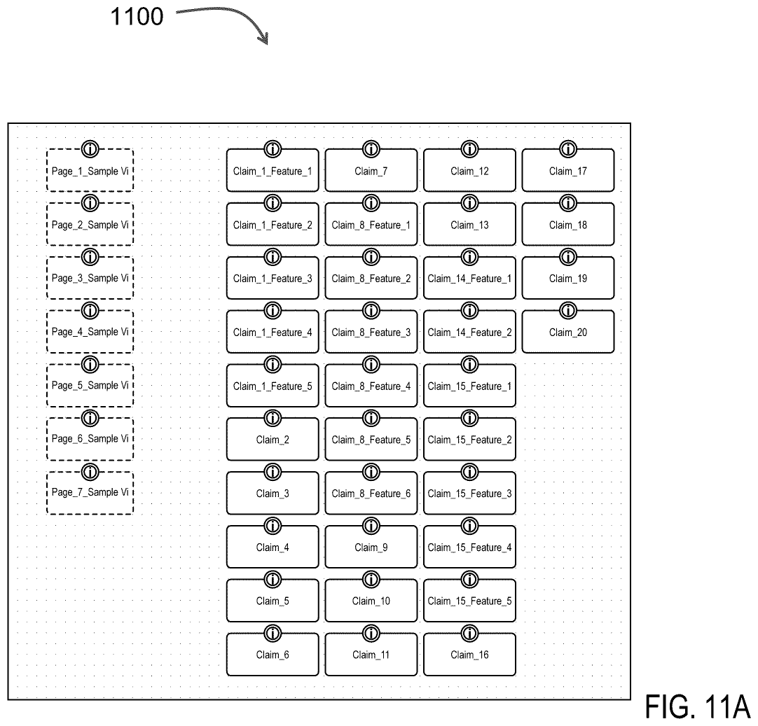

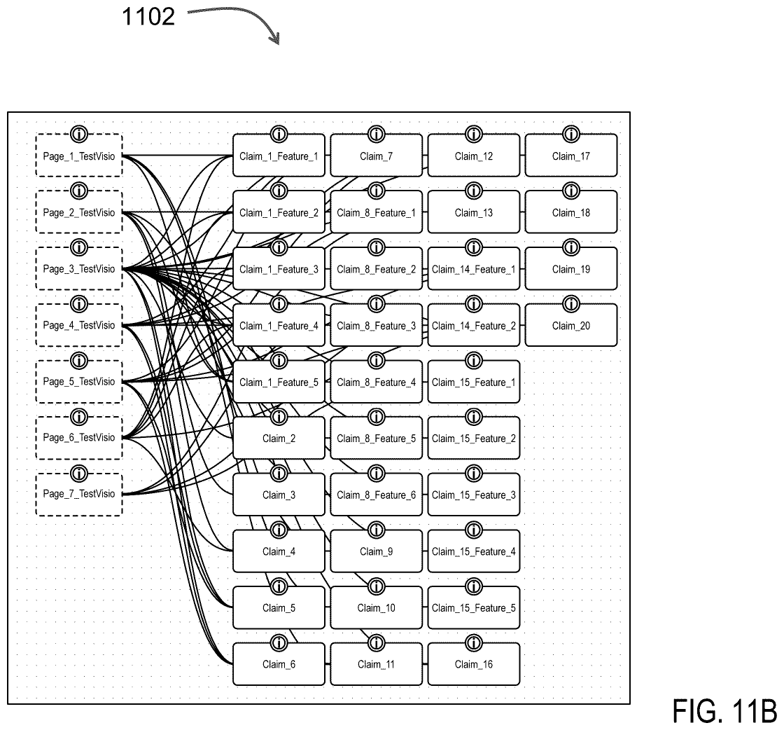

According to some embodiments, the transmitter 10 includes a data encoder 101 configured to encode the transmission data stream 16 by ensuring that data has a specific relationship (e.g., see mapping mechanisms shown in FIGS. 2B and 11A-11B), that enables the receiver 20 to extract the data from the coded data stream (e.g., transition-encoded) transmitted over the communication channel 15. In some embodiments, the data encoder 101 may include an element validation module (not shown) which confirm the mapping of each of the text features, C′, with each of the images, I.

In some embodiments, the data encoder 101 is configured to guarantee decoding of the mapped data instances in the transmission data stream 16.

As shown in FIG. 1B, the operations performed by the constituent components of the transmitter 10 and the receiver 20 may be performed by a “processing circuit” or “processor” 30 that may include any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed wiring board (PWB) or distributed over several interconnected PWBs. A processing circuit may contain other processing circuits; for example, a processing circuit may include two processing circuits, an FPGA and a CPU, interconnected on a PWB. A processor memory 32 that is local to the processor 30 may have stored thereon instructions that, when executed by the processor 30, cause the processor 30 to perform the operations described herein with respect to FIGS. 2A-15C. For example, the processor may be configured to include an element validation module which may validate the mapping of each of the text features, C′, with each of the images, I.

Referring to FIGS. 2A and 2B, there is shown a block diagram depicting input sources and output examples for the automated draft generation system, according to some embodiments of the present disclosure.

The automated draft generation system 202 may include one or more inputs 200 from user 205, extraction module 220, first extracted data 240, second extracted data 242, a first mapping module 244, second mapping module 246, a first neural network (e.g., fine-tuned LLM 248) and an output document 250.

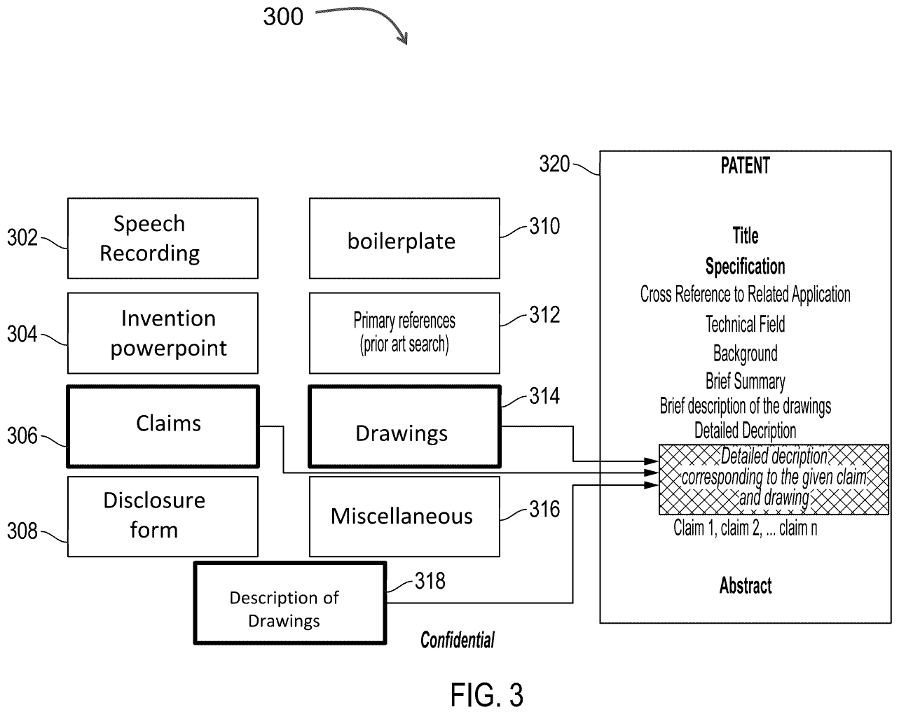

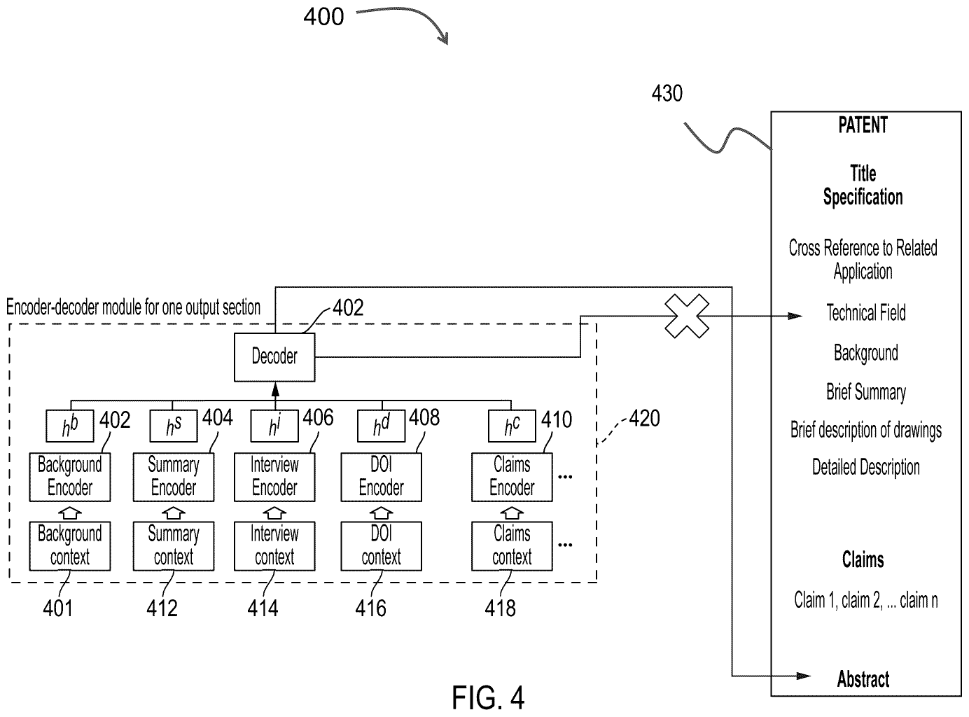

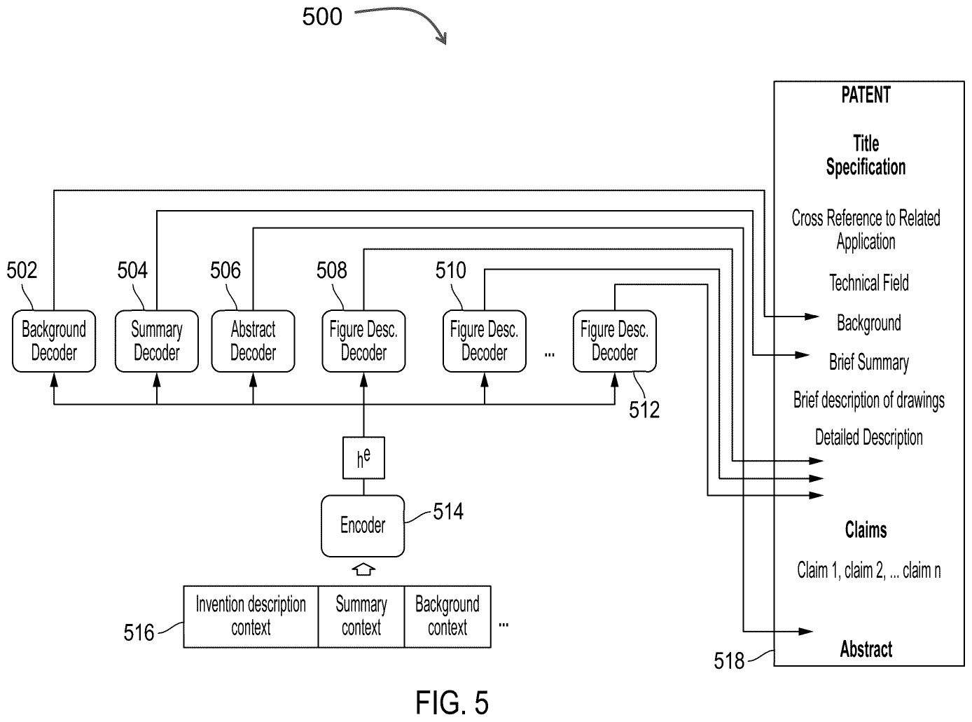

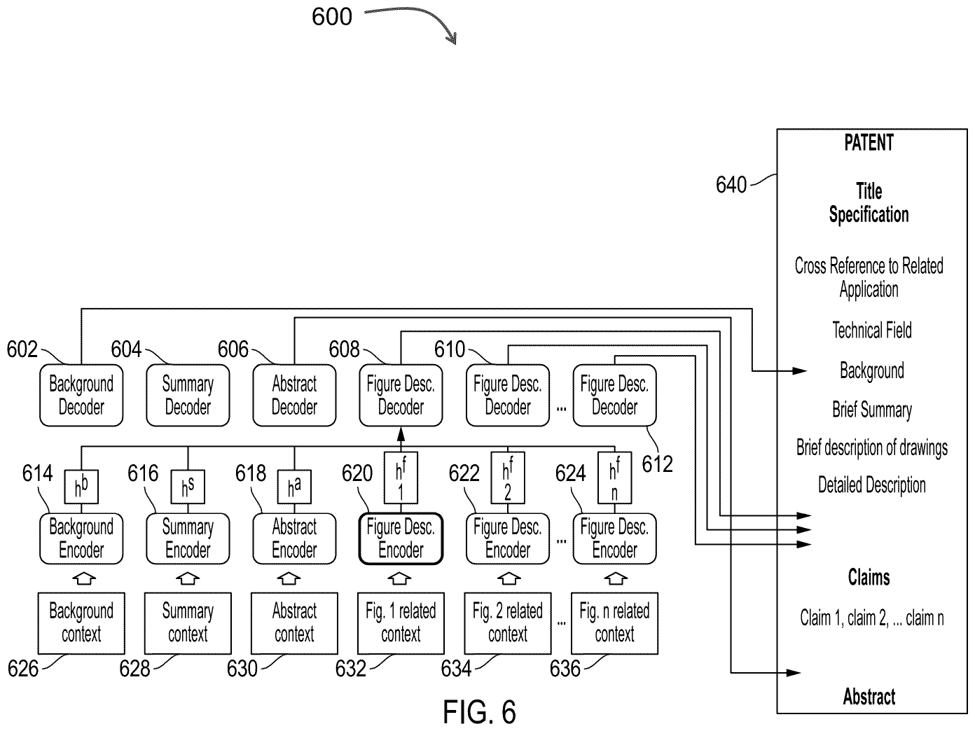

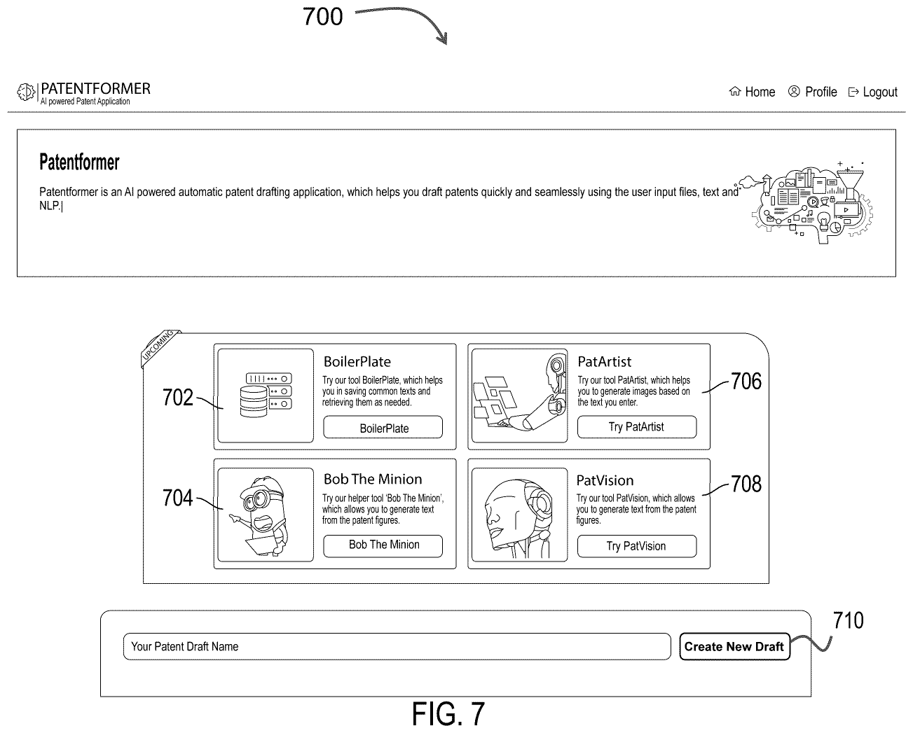

The one or more inputs 200 may include patent claims (also referred to herein as claims), C and images, I (e.g., shown in FIG. 2A as FIG. 1, FIG. 2, FIG. 3, FIG. 4, FIG. 5, FIG. 6 and FIG. 7). In another embodiment, the one or more inputs may include a number of different types of data inputs as shown in FIG. 3 (e.g., attorney interview speech recording 302, invention power-point 304, claim 306, disclosure form 308, boilerplate 310, primary references 312, drawings 314, miscellaneous 316 and description of drawings 318) but are not limited to these examples.

The automated draft generation system 202 may be configured to generate detailed text (e.g., detailed text for output document 250) that directly corresponds to the provided inputs (e.g., inputs 200, or various input sources shown and described in reference to FIG. 3).

Formally, let P represent a patent document consisting of:

A sequence of I claims, denoted as C={c1, c2, . . . , cl}.

A sequence of m specification paragraphs, denoted as S={s1, s2, . . . , sm}.

A set of t drawing images, denoted as I={i1, i2, . . . , it}.

A set of t brief descriptions of the drawings, denoted as B={b1, b2, . . . , bt}, where each bt corresponds to an image in the set of images, i∈I.

For each drawing image iz∈I, let nz represent a set of k pairs of component names and their corresponding component numbers appearing in the drawing.

Formally, we define:

$${n}_{z} = \{ < {i}_{{z}_{1}}^{name} , {i}_{{z}_{1}}^{num} > , < {i}_{{z}_{2}}^{name} , {i}_{{z}_{2}}^{num} > , … , < {i}_{{z}_{k}}^{name} , {i}_{{z}_{k}}^{num} > \} , \\ where {i}_{{z}_{j}}^{name}$$

denotes the name of the jth component, and i_{z}_{ⱼ}^{num} represents its corresponding number in the image iz. The complete set of component name-number pairs across all images is denoted as N={n1, n2, . . . , nt}.

The generated specification (e.g., output document 250) may: i) incorporate and support all the features present in the claims C (e.g., input source 200), ii) accurately describe the drawings using the drawing descriptions B., and iii) correctly reference the components in the drawings by utilizing the component name-number pairs in N. This process is formally expressed as T→S, where T represents the combined input information {C,B,N} used to generate the output specification S (e.g., output document 250).

The extraction module 220 may be an automated text and optical character recognition module. In some embodiments, the extraction module 220 may extract data from the one or more inputs 200. Various types of data may be extracted and this may be dependent on the input type. For example, the following types of data may be extracted: patent claim text C, from the one or more inputs (e.g., patent claims or patent claim features 242), images, I may be extracted (e.g., FIG. 3, shown as extracted data 240 in FIG. 2A. Also shown for the extracted data 240 are component names and numbers for each of the images, i_{z}^{num}, in I such as gesture prediction engine 302, machine learning model 304, predicted gestures 310, first sensor output 306, nth sensor output 308, wireless audio output device 104), description of images, B (e.g., Figure Description 241 in FIG. 2A).

In some embodiments, instead of using the plain text for training neural network (e.g., first neural network 248), e.g., T=(C, B, N), automated draft generation system 202 designs a rich version of T as T′=(C′, B′, N′), and generates the processed S′. That is, automated draft generation system 202 targets the task of T′→S′, instead of T→S, as described next. Specifically, for each claim feature extracted from an independent claim, the provided context may include the remaining claim features of that claim. For a claim feature extracted from a dependent claim, the context may include any remaining claim features along with its parent claim. Then, special tags may be embedded in both the input and output specifications to indicate the presence of figure numbers, component names, and component numbers within the training data. Furthermore, additional context may be provided by incorporating the previous paragraph, paragraph number, and the current paragraph number to help the model generate a coherent specification. Automated draft generation system 202 may use the enhanced versions of C, N, S and B as C′, N′, S′, and B′. The user 205 may provide the claims C, and the images I with descriptions B to the draft generation system and the system may enhance the inputs automatically to an enhanced text version, e.g., C′, N′, and B′.

This process may be incredibly valuable when considering, as mentioned before, that most generative LLMs are limited by their token lengths, e.g., 512, 1024, 2048, or 8192.

As shown in FIG. 2B, system 202 further includes a mapping mechanism. The mapping mechanism may define a relationship between the extracted data. In some embodiments, the mapping mechanism is manually user defined. In other embodiments, the mapping mechanism is automated. The mapping mechanism may include a figure to claim feature mapping system 244 and a claim feature to component mapping system 246.

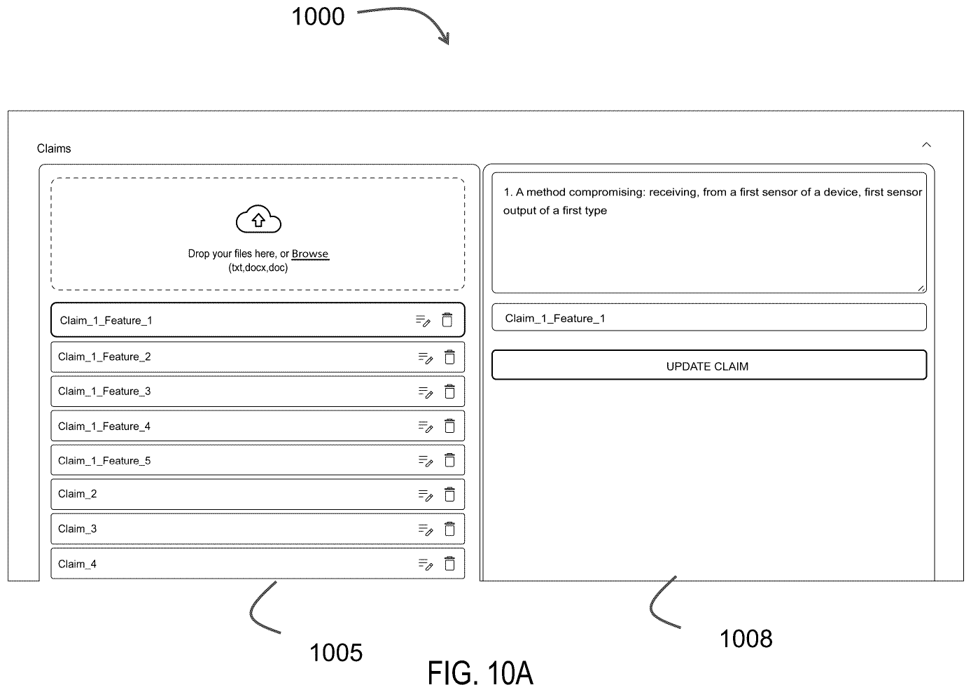

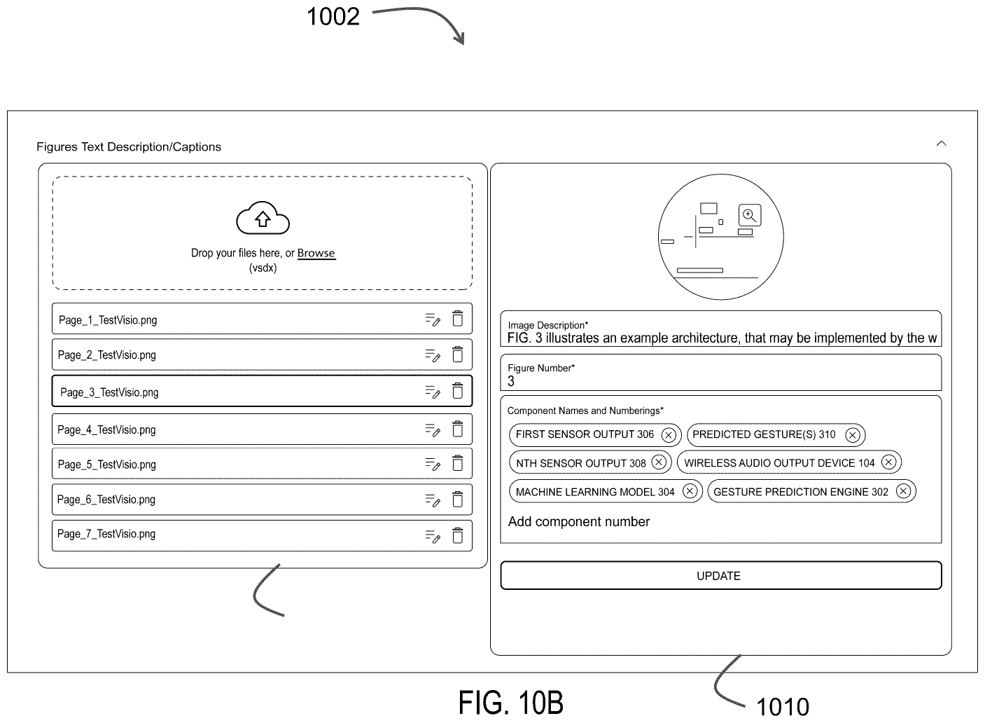

Mapping mechanism of automated draft generation system 202 may allow the users 205 to define relationships among various claims and drawing features, including components and descriptions. As illustrated in FIG. 10A, the interface initially displays unlinked claims and drawing features. Users can then manually establish connections between these elements by specifying relationships through the user interface, as shown in FIG. 10B. For example, a user 205 may indicate that the drawing feature labeled “Page 1 My Visio” corresponds to Claim Feature 1. This mapping process ensures that the generated patent specification accurately aligns claims with their respective visual components.

Figure to claim feature mapping system 244 may include mapping each of the extracted text features, C′, with at least one of the images, I. For example, as shown in FIG. 2A, FIG. 1 is mapped to claim 1—feature 1, claim 5—feature 3, claim 1—feature 2. As such, individual images can be mapped to more than one claim feature. Claim feature to component mapping system 246 maps each of the extracted component names, Z, and component numbers, num, for each of the images, i_{z}^{num}, with at least one of the extracted text features, C′. For example, claim 1, feature 3 is mapped to component names and numbers as follows: first sensor output 306, nth sensor output 308, machine learning model 304, and predicted gestures 310.

Automated draft generation system 202 may also include mapping mechanism for image description, B, to an extracted text feature, C′ (not shown).

Based on the various mappings, the automated draft generation system 202 may automatically prepare the linked mapping model input T′ and sends it to the fine-tuned large language model (LLM) 248. Finally, the model outputs the generated specifications, S′ 250.

In some embodiments, the mapped claim, along with its associated components, is processed into a structured text input tuple, denoted as T′=C′, N′, and B′, which is then passed to the underlying fine-tuned LLM. The LLM generates an enriched version of the patent specification, S′, for each claim. Before presenting the output to the user 205, a final postprocessing step refines it to conform to standard patent writing conventions.

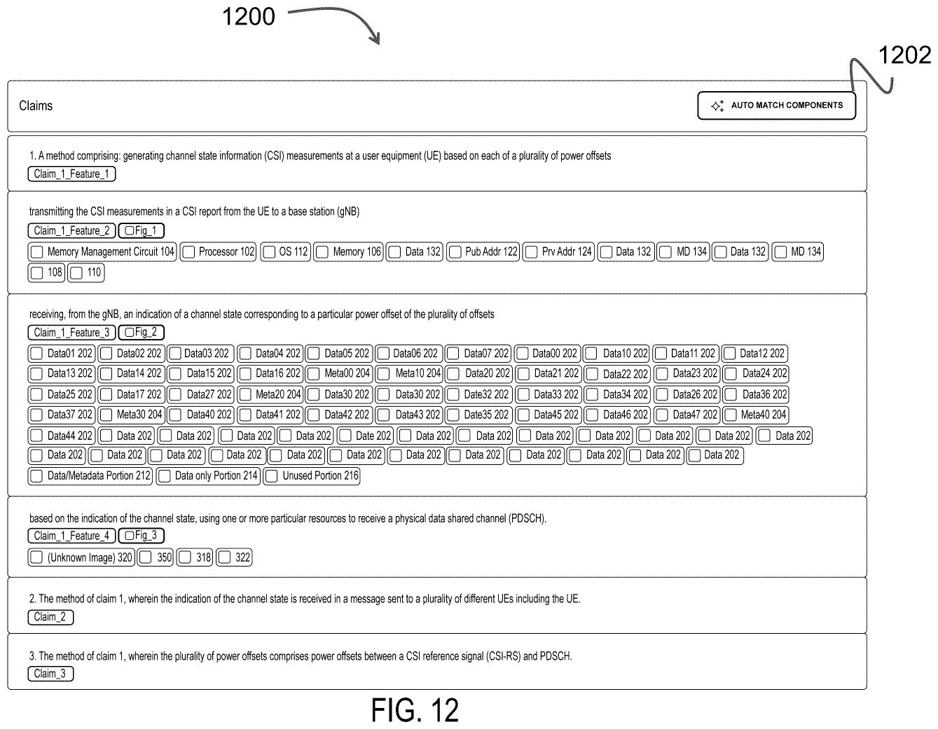

In this way, the mapping mechanism defines a relationship between the each of the extracted data, and may be automated (e.g., see auto match component module 1202 in FIG. 12) or user defined. The mapping of each of the text features, C′, with each of the images, I, may be confirmed or validated using an element validation module.

FIG. 3 is a block diagram depicting various input types for the encoder and various output types for the decoder for the draft generation system, according to some embodiments of the present disclosure. Some of the data inputs may include speech recordings 302, power point documents 304, patent claim 306, disclosure form 308, boilerplate text 310, primary reference 312, drawings 314, miscellaneous data 316 and description of drawings 318. Based on the various inputs, the system 202 may generate one or more portions of a patent document 320. For example, the various inputs (e.g., claim 306) may generate portions of the detailed description portion of the patent document 320.

FIG. 4 is a diagram depicting multiple encoder-single decoder for the draft generation system, according to some embodiments of the present disclosure. In this specific draft generation system 400, there are multiple encoder inputs and only one decoder output. The various data inputs (e.g., data inputs 200) may include documents such as: background context 401, summary context 412, interview context 414 (e.g., inventor interview recording), disclosure of invention context 416 and claims context 418. Data may be extracted for the various data inputs, resulting in extracted data. The various steps described in relation to FIGS. 2A and 2B may occur, resulting in this multiple encoder—single decoder model generating a portion of the patent specification. In some embodiments, the multiple encoder-single decoder model 400 may only be able to generate an abstract for a patent document 430.

FIG. 5 is a diagram depicting single encoder-multiple decoder for the draft generation system, according to some embodiments of the present disclosure. In this specific draft generation system 500, the single encoder may be an input combination 516 of the invention description context, summary context and background context. Based on the various inputs, the system 500 may generate one or more portions of a patent document 320. For example, the various inputs (e.g., claim 306) may generate portions of the detailed description portion of the patent document 540.

FIG. 6 is a diagram depicting a multiple encoder-multiple decoder for the draft generation system, according to some embodiments of the present disclosure. In this specific draft generation system 600, the multiple encoders may be similar to those described for FIG. 4. For example, the multiple encoders may include background encoder 614, summary encoder 616, abstract encoder 618, first figure description encoder 620, second figure description encoder 622, third figure description encoder 624, background context 626, summary context 628, abstract context 630, FIG. 1 related context 632, FIG. 2 related context 634 and FIG. n related context 636. In this specific draft generation system 600, the multiple decoders may include background decoder 602, summary decoder 604, abstract decoder 606, first figure description decoder 608, second figure description decoder 610 and third figure description decoder 612.

FIG. 7 depicts an exemplary home page graphical user interface (GUI) for the draft generation system, according to some embodiments of the present disclosure. Home page 700 may appear after a user logs-into system 202 successfully. In other embodiments, home page 700 may be a default landing page. This home page 700 presents users with a create new draft section, where the user gives names and creates a new patent draft to start the patent drafting journey. This page also presents user with some other helpful tools includer boilerplate module 702, PatArtist module 706, Bob The Minion module 704 and PatVision module 708. Boilerplate module 702 may be general boilerplate legal language based on technology area. Bob the Minion is a tool to extract the context from the multiple inputs, PatVision module 708 may be a tool to generate text based on input image and the input text, and PatArtist module 706 may be a tool to generate image based on the input text.

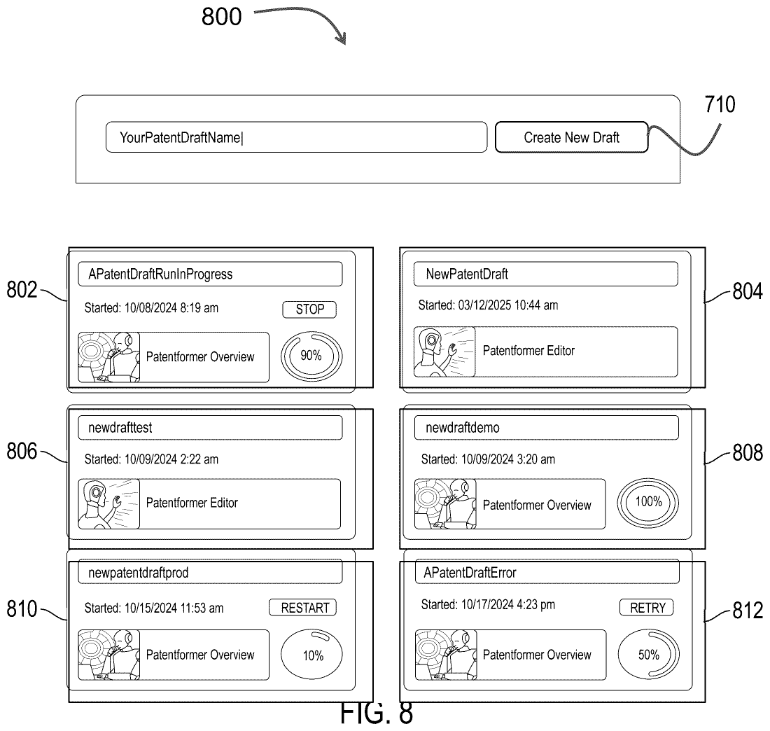

FIG. 8 depicts a drafts page GUI depicting various drafts created by a user (e.g., user 205) for the draft generation system, according to some embodiments of the present disclosure. The spherical progress bar shows the completion percentage of the run that user has started. User 205 has options to stop her/his run, retry a failed run and restart a stopped run based on patent draft status. When user visits home page 700, the user can monitor the status of different drafts, create a draft that user wants to work on and select on the card to navigate to input or overview page.

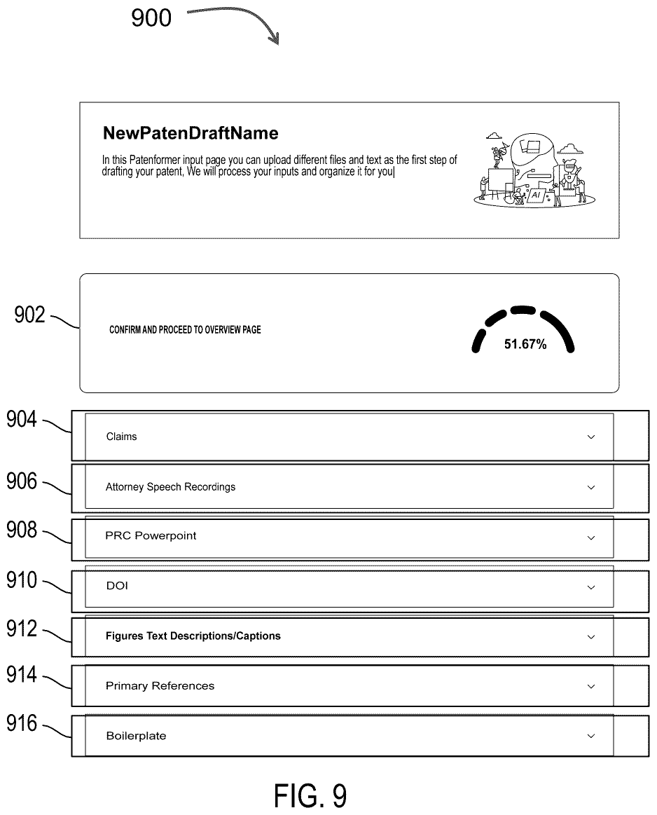

FIG. 9 depicts an input page, where input documents are uploaded for the draft generation system, according to some embodiments of the present disclosure. Data inputs may include claims 904, DOI 910, Speech recordings 906, invention power point 908, primary references 914. Once the user uploads and processes all documents, user will navigate to overview page for final steps. The score meter on the banner indicates the percentage of completion of a user uploading her/his documents and required inputs.

FIG. 10A depicts an input claims GUI page for the draft generation system, according to some embodiments of the present disclosure. In some embodiments, draft generation system 202 requires the user to upload the claim text 1005, denoted as C, and the corresponding drawing figures, 1006.

Draft generation system 202 may process the claim text 1005 and figures 1006. This preprocessing step includes generating structured claim features from the claim text and automatically identifying key components and their respective numbers, denoted as N′, within the drawings. Additionally, the user may modify the processed text and manually add an image description, B, through the claim interactive interface 1008 and figure interactive interface 1010. Once these inputs are finalized, draft generation system 202 may further refine and enhance them, resulting in transformed representations such as the enhanced claim text C′,

In some embodiments, the user can drag and drop files to upload or can use the browse link to upload documents to Claims or Figures. The application will automatically process the claims document into claim features and Visio drawings to multiple figure files. For the figures section, the user further needs to provide Image descriptions and verify the figure number, component names and numbers by looking at the image shown that are automatically generated.

FIG. 10B depicts input figures GUI for the draft generation system, according to some embodiments of the present disclosure. This is an overview page, where the user will do the final steps before starting a run and can see the run information presented in the run information section. User clicks on Generate Patent Draft button to start a run and send the finalized inputs to the trained model.

FIGS. 11A-11B depict a claim feature mapping GUI, according to some embodiments of the present disclosure.

Once draft generation system 202 has processed the text 1005 and figures 1006, the platform presents a mapping GUI 1100, allowing the user(s) to define relationships among various claims and drawing features, including components and descriptions. As illustrated in FIG. 11A, the interface initially displays unlinked claims and drawing features. Users can then manually establish connections between these elements by specifying relationships through the user interface, as shown in FIG. 11B. For example, user may indicate that the drawing feature labeled “Page 1 My Visio” corresponds to Claim Feature 1. This mapping process ensures that the generated patent specification accurately aligns claims with their respective visual components.

In some embodiments, specific color options may be available in the mapping GUI 1100. The mapping GUI 1100 may display the figures in a specific color and claim features in another distinct color different from the figures. These mappings may represent the relations between figures and claim features, which will help in passing the structured input to the model. During the claim feature mapping, a user can opt to view full screen, zoom in and zoom out. User can click on information icon and view the figure or the claim feature text. Mappings may include, yet are not limited to: mapping each of the extracted text features, C′, with at least one of the images, I and mapping each of the extracted component names, Z, and component numbers, num, for each of the images, i_{z}^{num}, with at least one of the extracted text features, C.

In some embodiments, the mapping mechanism further includes: mapping at least a first image description, B′, to an extracted text feature, C′. The mapping mechanism defines a relationship between the each of the extracted data. The mapping mechanism is manually user defined. validating the mapping of each of the extracted text, C′, with each of the images, I, using, for example an element validation module.

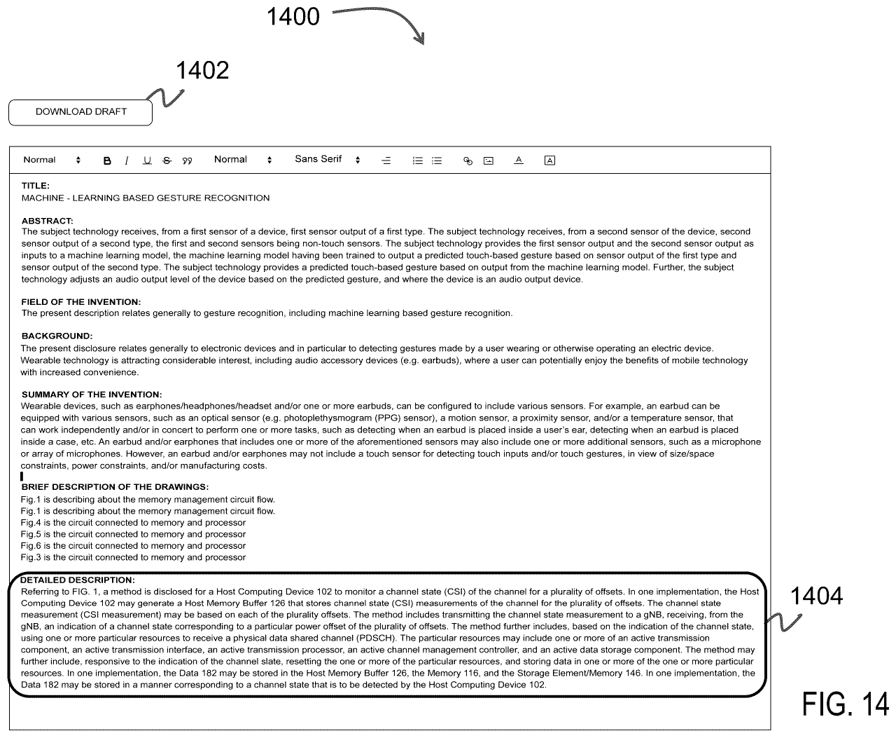

In some embodiments, each mapped claim, along with its associated components, is processed into a structured text input tuple, denoted as T′=C′, N′, and B′, which is then passed to the underlying fine-tuned LLM (e.g., fine-tuned LLM 248). The LLM generates an enriched version of the patent specification, S′, for each claim. Before presenting the output to the user, a final postprocessing step refines it to conform to standard patent writing conventions. FIG. 14 provides an example of the generated patent specification produced by system 202.

FIG. 12 depicts mapping component names and numbers to claim features for the draft generation system 202. In some embodiments, a user can auto match the component name and numbers by selecting an auto match components button 1202. Once the automated matching of component names and numbers is completed, a validation process may be needed to confirm that the automated matching is accurate. In order to automatically match the components corresponding to claims feature, we implemented a simple strategy that matches each component name with the claim features based on cosine similarity and BLEU-1 and BLEU-2 scores; we used a threshold of 0.1 to select up to top five matching components with each claim feature. This strategy resulted in precision@5 of 0.565 and precision@3 of 0.6 based on approximately 6,000 samples. We implemented a strategy to match components to claim features using cosine similarity, BLEU-1 and BLEU-2 scores. We then measured how many of the top 3 matching components were included in the actual specification, and how many of the top 5 matching components were included in the actual specification. The precision @3 and precision@5 scores are for the actual matchings.

Alternatively, a user can select checkboxes directly to map component numbers to respective claim feature. Once the component names and numbers mapping to claim feature is completed, the user can now send the mappings and other inputs to the A1 model. This step is completed by starting a programmatic run by selecting a Generate Patent Draft selection.

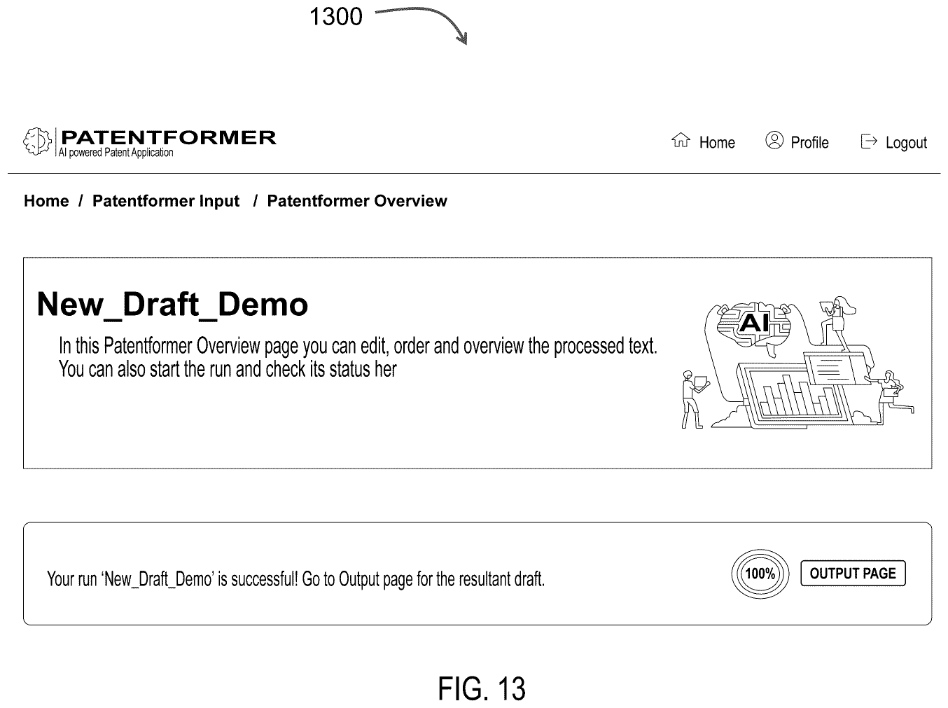

FIG. 13 depicts a draft output GUI for the draft generation system, according to some embodiments of the present disclosure. The draft output GUI 1300 may be presented once a document generation run is started and completed successfully. A user will be presented with an output page button 1304, where the user can click and go to the output page to see the model generated text document (e.g., specific text generated for a patent specification).

FIG. 14 depicts a draft editing GUI for the draft generation system, according to some embodiments of the present disclosure.

The draft editing GUI 1400 may be an editing tool where a user can edit and finalize the ANN model generated draft. Any changes to the generated text document by a user will be saved. The user can also download the finalized draft by selecting the download draft button 1402. In other embodiments, the draft editing GUI 1400 may serve as a review tool for the user to determine if the generated text accurately corresponds with the input claims, figures, or other input sources.

For example, the processed text section, 1404, may be generated as the output based on the mapped data instances (e.g., mapped data instances XX). A determination may be made if the processed text section 1404 (e.g., first processed text section) accurately corresponds to the first set of mapped data instances. In some embodiments, if the first processed text section does not accurately correspond to the mapped data instances, a revised processed text section rS may be generated by the decoder.

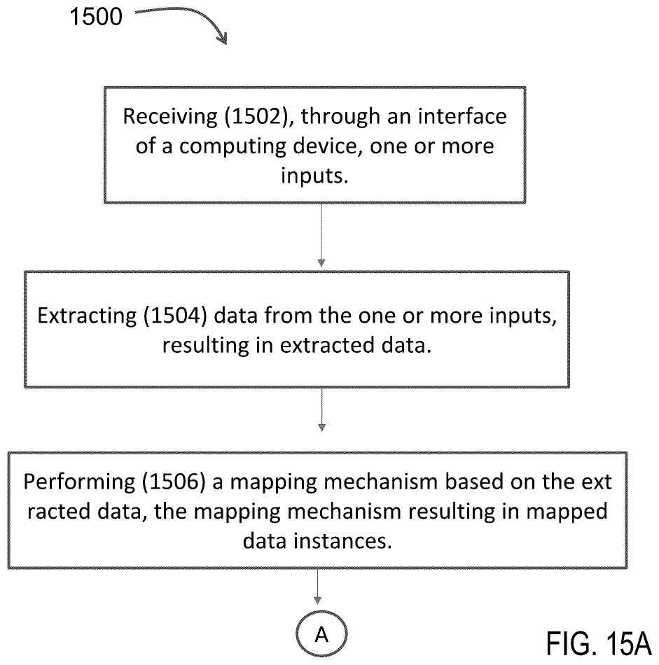

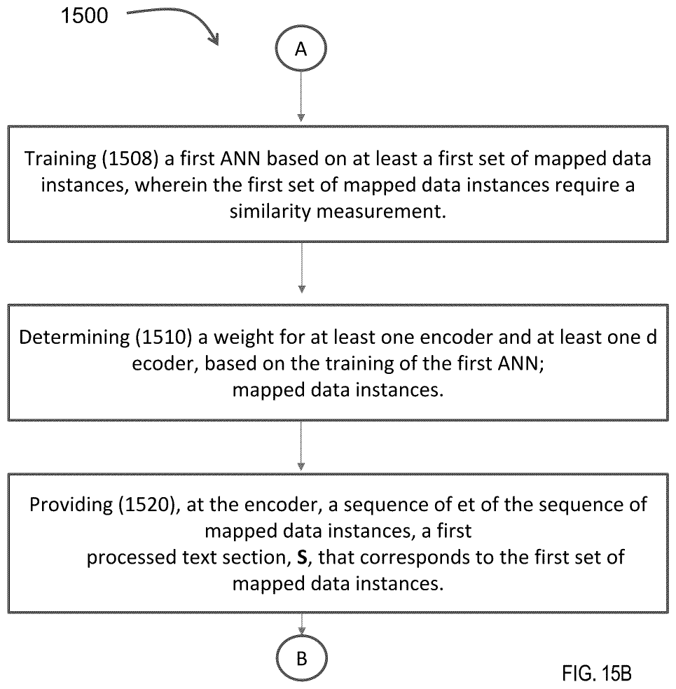

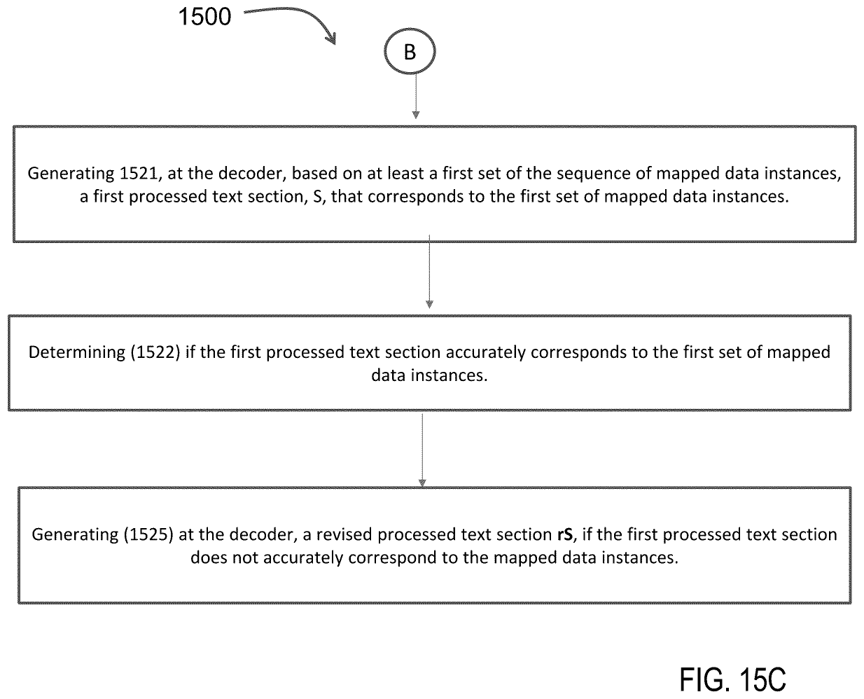

FIG. 15 is a flowchart depicting example operations of a method for using an artificial neural network (ANN) for automated document generation, according to some embodiments of the present disclosure. The method shown in FIG. 15 is depicted in FIGS. 2A-14.

The method 1500 may include receiving 1502, through an interface of a computing device, one or more inputs.

The method 1500 may include extracting 1504 data from the one or more inputs, resulting in extracted data. Extracting data may include extracting text, C, from the one or more inputs, generating text features, C′ for each of an extracted text C, extracting images, I, from the one or more inputs, extracting description of images, B, from the one or more inputs and extracting component names, Z, and component numbers, num, for each of the images,

$${i}_{z}^{num} ,$$

in I. Extracting text, C, from the one or more inputs may include extracting a sequence of patent claims for a first patent document.

The method 1500 may include performing 1506 a mapping mechanism based on the extracted data, the mapping mechanism resulting in mapped data instances. The mapping mechanism may include mapping each of the text features, C′, with at least one of the images, I; and mapping each of the component names, Z, and component numbers, num, for each of the images,

$${i}_{z}^{num} ,$$

with at least one of the text features, C. The mapping mechanism may further includer mapping at least a first image description, B′, to an extracted text feature, C′. The mapping mechanism may define a relationship between the each of the extracted data. In some embodiments the mapping mechanism is manually user defined. The method 1500 may further include validating the mapping of each of the text features, C′, with each of the images, I, using an element validation module, training a second artificial neural network configured to receive one or more outputs of the first artificial neural network and generate a specific text output.

The method 1500 may include training 1508 a first ANN based on at least a first set of mapped data instances, wherein the first set of mapped data instances require a similarity measurement.

The method 1500 may include determining 1510 a weight for at least one encoder and at least one decoder, based on the training of the first ANN.

The method 1500 may include providing 1520, at the encoder, a sequence of mapped data instances.

The method 1500 may include generating 1521, at the decoder, based on at least a first set of the sequence of mapped data instances, a first processed text section, S, that corresponds to the first set of mapped data instances.

The method 1500 may include determining 1522, if the first processed text section accurately corresponds to the first set of mapped data instances.

The method 1500 may include generating 1525, at the decoder, a revised processed text section (e.g., rS, if the first processed text section does not accurately correspond to the mapped data instances.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

What is claimed is:

1. A method of using an artificial neural network (ANN) for automated text generation, the method comprising:
a) receiving, through an interface of a computing device, one or more inputs;
b) extracting data from the one or more inputs, resulting in extracted data;
c) performing a mapping mechanism based on the extracted data, the mapping mechanism resulting in mapped data instances;
d) training a first artificial neural network based on at least a first set of mapped data instances, wherein the first set of mapped data instances require a similarity measurement;
e) determining a weight for at least one encoder and at least one decoder, based on the training of the first artificial neural network;
f) providing, at the encoder, a sequence of mapped data instances;
g) generating, at the decoder, based on at least a first set of the sequence of mapped data instances, a first processed text section, S, that corresponds to the first set of mapped data instances;
h) determining if the first processed text section accurately corresponds to the first set of mapped data instances; and
i) generating, at the decoder, a revised processed text section rS, if the first processed text section in (g) does not accurately correspond to the mapped data instances.

2. The method of claim 1, wherein extracting data includes:
(a) extracting text, C, from the one or more inputs,
(b) generating text features, C′ for each of an extracted text C;
(c) extracting images, I, from the one or more inputs;
(d) extracting description of images, B, from the one or more inputs; and
(e) extracting component names, Z, and component numbers, num, for each of the images,
$${i}_{z}^{num} ,$$
10 in I.

3. The method of claim 2, wherein extracting text, C, from the one or more inputs includes extracting a sequence of patent claims for a first patent document.

4. The method of claim 2, wherein the mapping mechanism includes:
a) mapping each of the text features, C′, with at least one of the images, I; and
b) mapping each of the component names, Z, and component numbers, num, for each of the images,
$${i}_{z}^{num} ,$$
with at least one of the text features, C.

5. The method of claim 4, wherein the mapping mechanism further includes: mapping at least a first image description, B′, to an extracted text feature, C′.

6. The method of claim 4, wherein the mapping mechanism defines a relationship between the each of the extracted data.

7. The method of claim 4, wherein the mapping mechanism is manually user defined.

8. The method of claim 4, further including:
validating the mapping of each of the text features, C′, with each of the images, I, using an element validation module.

9. The method of claim 1, further including:
training a second artificial neural network configured to receive one or more outputs of the first artificial neural network and generate a specific text output.

10. The method of claim 1, wherein a weight of each encoder and a weigh of each decoder of the first ANN is derived from the training of the first ANN, based on at least the first set of mapped data instances.

11. The method of claim 1, wherein the first processed text section can be any text document including a patent document.

12. The method of claim 11, wherein the processed text section is one or more portions of the patent document.

13. The method of claim 1, wherein the similarity measurement is a threshold between 0.1-0.3.

14. The method of claim 1, wherein the similarity measurement depends on cosine similarity and BLEU-1 and BLEU-2 scores.

15. The method of claim 1, wherein accurately corresponding to the first set of mapped data instances requires that the first processed text section accurately describes the first set of mapped data instances.

16. A method of using an artificial neural network (ANN) for automated text generation,
the method using a transformer, a set of multiple encoders and multiple decoders, the method comprising:
a) obtaining training data by using at least one text input according to a text source category and using a corresponding output text (separated by a target category);
b) generating output vectors representing a probabilistic distribution over various elements of a text descriptive library from the decoder;
c) determining an error measure between an outputted probabilistic distributions and a ground truth text from the training data; and
d) modifying at least one parameter of a sequence-sequence multiple encoders-multiple decoders model based on the error measure.

17. A computer-implemented method of generating output data, the method being performed by at least one processor and comprising:
(a) receiving, through an interface of a computing device, one or more inputs;
(b) extracting data from the one or more inputs, resulting in extracted data;
(c) performing a mapping mechanism based on the extracted data, the mapping mechanism resulting in mapped data instances;
(d) training a first artificial neural network based on at least a first set of mapped data instances, wherein the first set of mapped data instances require a similarity measurement
(e) determining a weight for at least one encoder and at least one decoder, based on the training of the artificial neural network;
(f) providing, at the encoder, a sequence of mapped data instances;
(g) generating, at the decoder, based on at least a first set of the sequence of mapped data instances, a first processed text section, S,
(h) determining if the first processed text section accurately correspond to the mapped data instances; and
(i) generating, at the decoder, a revised processed text section rS, if the first processed text section in (h) does not accurately correspond to the mapped data instances.

18. A method for encoding data for transmission from a source to a destination over a communication channel, the method being performed by at least one processor and comprising:
a) obtaining a data stream comprising a plurality of inputs;
b) extracting data from the one or more inputs, resulting in a plurality of extracted data
c) determining a matching of each extracted data of the plurality of extracted data from a first encoder table, resulting in a plurality of matched data instances;
d) encoding, at an encoder, a similarity measurement of a first set of mapped data instances of a plurality of mapped data instances;
e) training a first neural network based on at least a first set of mapped data instances;
f) generating a weight for the encoder based on the training of the first neural network;
g) providing at the encoder a first sequence of mapped of data instances;
h) applying an encoding function to each mapped data instance of the first sequence of mapped of data instances;
i) generating, at a decoder, based on at least a first set of the first sequence of mapped data instances, a first processed text section, S;
j) determining if the first processed text section accurately describes the mapped data instances; and
k) regenerating, at the decoder, a revised processed text section rS, if the first processed text section in (i) does not accurately describe the mapped data instances.

19. A method of decoding a sequence of mapped data instances, the method comprising:
a) obtaining a first sequence of mapped data instances;
b) decoding a first mapped data instance from the first sequence of mapped data instances;
c) mapping an output S′ for the first mapped data instance based on a training of a first neural network using probabilistic distributions of each decoder to generate a next more probable word;
d) determining, based on the mapping of output S′ for the first mapped data instance, whether a constraint violation is met;
e) re-mapping an output S′ for the first mapped data instance if the constraint violation is not met; and
f) generating an output stream by iteratively applying a decoding function to each mapped data instance of the first sequence of mapped data instances.

20. The method of claim 18, wherein a similarity measurement is a threshold between 0.1-0.3.
